(19) United States
(12) Patent Application Publication
(10) Pub. No.: US 2022/0318689 A1
(43) Pub. Date: Oct. 6, 2022

(54) Systems and Methods for Model Selection

(71) Applicant: Unlearn.AI, Inc., San Francisco, CA (US)

(72) Inventors: David Li-Bland, Oakland, CA (US); Aaron Michael Smith, Corte Madera, CA (US); Anton D. Loukianov, San Mateo, CA (US)

(73) Assignee: Unlearn.AI, Inc., San Francisco, CA (US)

(21) Appl. No.: 17/658,228

(22) Filed: Apr. 6, 2022

Related U.S. Application Data
(60) Provisional application No. 63/171,350, filed on Apr. 6, 2021.

(51) Int. Cl. G06N 20/20

(52) U.S. Cl. CPC G06N 20/20

(57) ABSTRACT

Systems and methods for model selection in accordance with embodiments of the invention are illustrated. One embodiment includes a method for ranking candidate models. The method includes steps for identifying several candidate models and a set of one or more scoring models for each of the several candidate models and determining a rank distribution for each of several model pairs, where each model pair of the several model pairs includes a candidate model of the several candidate models and a scoring model of the set of scoring models. The rank distribution for each model pair can be determined based on scores for the candidate model generated by the scoring model and scores generated by the scoring model for other candidate models of the several candidate models. The method further includes ranking the several models based on the determined rank distributions.

### CROSS-REFERENCE TO RELATED APPLICATIONS

The current application claims the benefit of and priority under 35 U.S.C. § 119(e) to U.S. Provisional Patent Application No. 63/171,350 entitled “Systems and Methods for Model Selection” filed Apr. 6, 2021. The disclosure of U.S. Provisional Patent Application No. 63/171,350 is hereby incorporated by reference in its entirety for all purposes.

### FIELD OF THE INVENTION

The present invention generally relates to model selection and, more specifically, selection of an optimal machine learning (ML) model according to one or more heterogeneous and noisy metrics of model quality.

### BACKGROUND

In machine learning, one often generates several models that perform some task (e.g. regression, classification, sample generation, etc.) from which one must select one “best” model. “best” must be determined by consulting criteria or scores that evaluate model quality, attempting to optimize such scores. The scores can be general or specific to the designed task, and can be noisy or probabilistic. Furthermore, there can be several scores measuring model quality that must be balanced.

### SUMMARY OF THE INVENTION

Systems and methods for model selection in accordance with embodiments of the invention are illustrated. One embodiment includes a method for ranking candidate models. The method includes steps for identifying several candidate models and a set of one or more scoring models for each of the several candidate models and determining a rank distribution for each of several model pairs, where each model pair of the several model pairs includes a candidate model of the several candidate models and a scoring model of the set of scoring models. The rank distribution for each model pair can be determined based on scores for the candidate model generated by the scoring model and scores generated by the scoring model for other candidate models of the several candidate models. The method further includes ranking the several models based on the determined rank distributions.

In a further embodiment, each of the several candidate models is trained to perform at least one task selected from the group consisting of regression, classification, and sample generation.

In still another embodiment, the set of scoring models are noisy and stochastic.

In a still further embodiment, at least one scoring model of the set of scoring models measures a characteristic of the candidate model, wherein the characteristic is selected from the group consisting of how well the given model captures a statistic of the data, statistical indistinguishability of samples drawn from the given model from samples of data being modeled, and a log-likelihood of the given model.

In yet another embodiment, determining a rank distribution for each of several model pairs includes fitting a weakly max-stable distribution to scores generated by the scoring model.

In a yet further embodiment, fitting the weakly max-stable distribution to argmin statistics comprises determining, for each model pair, probabilities that the candidate model is assigned an optimal score by the scoring model, and computing a negative log of the determined probabilities.

In another additional embodiment, the probabilities are determined based on several sample scores from the scoring model for the candidate model of the model pair.

In a further additional embodiment, ranking the several models based on the determined rank distributions includes computing a logsumexp of the computed negative log probabilities associated with each model pair.

In another embodiment again, the weakly max-stable distribution is fitted to pairwise order statistics based on the scores generated by the scoring model to determine the rank distribution.

In a further embodiment again, fitting the weakly max-stable distribution to the pairwise order statistics includes minimizing cross-entropy between empirical pairwise orderings of the scores and a proxy random function that approximates the weakly max-stable distribution to determine the rank distribution.

In still yet another embodiment, each of the empirical pairwise orderings includes a probability that a first candidate model is assigned a more optimal score than a second candidate model by a given scoring model.

In a still yet further embodiment, the more optimal score is a lower score.

In still another additional embodiment, the probability is determined based on several sample scores from the given scoring model for the first and second candidate models.

In a still further additional embodiment, ranking the several models based on the determined rank distributions includes computing a logsumexp of the rank distributions.

In still another embodiment again, the weakly max-stable distribution is a Gumbel distribution and fitting the Gumbel distribution includes computing a location parameter of the Gumbel distribution based on the scores generated by the scoring model.

In a still further embodiment again, the weakly max-stable distribution is an Exp-Gamma-Gumbel distribution.

In yet another additional embodiment, ranking the several models includes identifying a best model based on the determined rank distributions.

In a yet further additional embodiment, ranking the several models includes computing a logsumexp of the rank distributions of the several model pairs.

In yet another embodiment again, ranking the several models comprises aggregating the rank distributions for each of the several candidate models to generate a total rank distribution, and ranking the several models based on the total rank distributions.

In a yet further embodiment again, aggregating includes identifying a maximum rank distribution of the rank distributions for each of the several candidate models.

In another additional embodiment again, ranking the several models includes ensembling a subset of the several candidate models includes models with the lowest Gumbel ranks.

In a further additional embodiment again, ensembling the subset of the several candidate models is performed using uniform weights.

In still yet another additional embodiment, ensembling the subset of the several candidate models is performed using relative weights.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example of a process for selecting models in accordance with an embodiment of the invention.

FIG. 2 illustrates a chart of results in which scores for ten models were sampled ten times.

FIG. 3 illustrates an example of Gumbel rankings in accordance with an embodiment of the invention.

FIG. 4 illustrates a chart with the resulting values for p for the total Gumbel rank in accordance with an embodiment of the invention.

FIG. 5 illustrates an example of a model selection system that selects and/or ranks models in accordance with an embodiment of the invention.

FIG. 6 illustrates an example of a model selection element that executes instructions to perform processes that select and/or rank models in accordance with an embodiment of the invention.

FIG. 7 illustrates an example of a model selection application for selecting and/or ranking models in accordance with an embodiment of the invention.

### DETAILED DESCRIPTION

Systems and methods in accordance with several embodiments of the invention provide for the selection (and/or ranking) of the optimal model from a set of candidate models according to a collection of model quality scores. Processes in accordance with a variety of embodiments of the invention can define and solve for the “best” model, when there are multiple metrics and in the presence of noise. The problem of choosing the best model can be cast as a two-part problem of 1) replacing the given model scores with parametrized normalized random scores according to a fitting procedure, and then 2) aggregating the random scores in a balanced fashion to provide a “best” model selection.

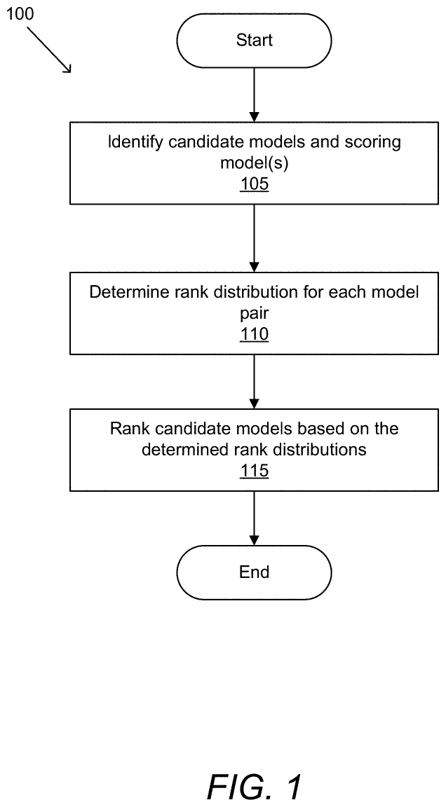

Processes in accordance with numerous embodiments of the invention can provide a number of key guarantees. Specifically processes can be invariant with respect to (order preserving) reparametrizations of the scoring functions, unaltered by including a duplicate scoring function (in the noiseless setting), and insensitive to noisy measurements. An example of a process for selecting models in accordance with an embodiment of the invention is conceptually illustrated in FIG. 1. Process 100 identifies (105) candidate models and one or more scoring models. In certain embodiments, each of the candidate models can be trained to perform regression, classification, and/or sample generation. Scoring models (or scoring functions) in accordance with some embodiments of the invention can be noisy and/or stochastic, making it difficult to reliably and accurately compare different candidate models. In several embodiments, scoring models can measure characteristics of each candidate model, such as (but not limited to) how well the given model captures a statistic of the data, statistical indistinguishability of samples drawn from the given model from samples of data being modeled, and/or a log-likelihood of the given model.

Process 100 determines (110) rank distributions for each model pair. Each model pair includes a candidate model and a scoring model. In a variety of embodiments, rank distributions for a model pair can be determined based on scores for the candidate model generated by the scoring model and scores generated by the scoring model for other candidate models of the several candidate models. Rank distributions in accordance with numerous embodiments of the invention can be determined by fitting a weakly max-stable distribution to scores generated by a scoring model. In various embodiments, rank distributions can be fitted to argmin statistics by determining, for each model pair, probabilities that a given candidate model is assigned an optimal score by the scoring model, and computing a negative log of the determined probabilities. The probabilities in accordance with a number of embodiments of the invention can be determined based on multiple sample scores from the scoring model for the candidate model of the model pair.

In several embodiments, weakly max-stable distributions can be fitted to pairwise order statistics based on the scores generated by the scoring model to determine the rank distribution. Fitting the weakly max-stable distribution to the pairwise order statistics in accordance with a number of embodiments of the invention can include minimizing cross-entropy between empirical pairwise orderings of the scores and a proxy random function that approximates the weakly max-stable distribution to determine the rank distribution. In several embodiments, each of the empirical pairwise orderings may include a probability that a first candidate model is assigned a more optimal score than a second candidate model by a given scoring model. Although many of the examples described the optimal score is a lower score, one skilled in the art will recognize that various different measures and/or scoring functions can be used in a variety of applications. In several embodiments, the probability can be determined based on several sample scores from the given scoring model for the first and second candidate models.

In a variety of embodiments, the weakly max-stable distribution can be any of various weakly max-stable distributions, such as (but not limited to) Gumbel distributions, Exp-Gamma-Gumbel distributions, etc. Fitting a Gumbel distribution in accordance with numerous embodiments of the invention can include computing a location parameter of the Gumbel distribution based on the scores generated by the scoring model. Ranking the several models in accordance with certain embodiments of the invention can include identifying a best model based on the determined rank distributions.

Process 100 ranks (115) the candidate models based on the determined rank distributions. Ranking the several models based on the determined rank distributions in accordance with various embodiments of the invention includes computing a logsumexp of the computed negative log probabilities associated with each model pair. Ranking the several models based on the determined rank distributions in accordance with many embodiments of the invention can include computing a logsumexp of the rank distributions. In a variety of embodiments, ranking the several models includes computing a logsumexp of the rank distributions of the several model pairs.

In a number of embodiments, ranking the several models comprises aggregating the rank distributions for each of the several candidate models to generate a total rank distribution, and ranking the several models based on the total rank distributions. Aggregating rank distributions in accordance with a variety of embodiments of the invention can include identifying a maximum rank distribution of the rank distributions for each of the several candidate models. In many embodiments, ranking the several models includes ensembling a subset of the several candidate models includes models with the lowest Gumbel ranks. Ensembling in accordance with certain embodiments of the invention can be performed using uniform weights and/or relative weights.

While specific processes for selecting and/or ranking models are described above, any of a variety of processes can be utilized to select and/or rank models as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Further descriptions and detail of systems and methods for selecting and/or ranking models in accordance with some embodiments of the invention are described below.

### A. Model Selection Desiderata

While building machine learning models, one is faced with the question: “From amongst a set of models [symbol] ={ [symbol] }ᵢ₌₀^{N}, which is the best?” To help answer this question, one can construct a number of different scoring functions (or scoring models) to score the models, for instance:
How well does a model [symbol] capture a specific statistic of the data (e.g. The mean of one variable conditioned on another),
The statistical indistinguishability of samples drawn from the model from samples of data being modeled (as measured by some statistical test),
The log-likelihood of the model, given the data, etc.
   Each of these scoring functions gives a general indication of whether one model is better than another, but none of them are sufficiently informative so as to determine which model is conclusively best; often a number of different scoring functions should be consulted to assess model quality. Moreover, the scoring functions are often noisy (e.g., random variables), have non-trivial correlations (since they are all correlated with the more fundamental but somewhat intractable notion of model quality), and/or not directly comparable, in the sense that they each may have different scales. It can be beneficial to have a method that combines the information provided in the values of these various scoring functions in order to select the best model in a way that handles the noise, variation, and/or correlation in the scores appropriately. Systems and methods in accordance with some embodiments of the invention can provide a solution of handling such a scenario that satisfies a number of important selection criteria. The next section outlines those criteria.

### B. Selection Criteria

To introduce some notation, denote the scoring functions Sⱼ: [symbol] → [symbol] . These are each random functions, and without loss of generality, in the examples described herein, better scores are smaller (so the scores represent losses). Selection processes in accordance with a variety of embodiments of the invention can be invariant with respect to (order persevering) reparameterizations of the scoring functions. For instance, replacing a scoring function Sⱼ with 3Sⱼ+4, or log(Sⱼ), should not alter the outcome of the selection process.

In a variety of embodiments, selection processes can be unaltered by including a duplicate scoring function. For instance, if the scoring function S′=Sⱼ (for a particular j) is (inadvertently) added to the distinguished set of scoring functions it should not alter the outcome of the selection process. As an example, if the first three scoring functions S₀, S₁, S₂ are all strongly correlated (carry essentially the same information), they could be effectively replaced by a single one.

Selection processes in accordance with numerous embodiments of the invention can be inherently insensitive to noisy measurements. That is to say, the selection process should converge given sufficient measurements of the random scores Sⱼ( [symbol] )

### C. Selection Method

In numerous embodiments, given the scoring functions {Sⱼ} and models [symbol] , selection methods can be specified by assignments,
ρ:( [symbol] ,Sⱼ) [symbol] {ρᵢⱼϵ [symbol] },
   that associate any pair of model and scoring function to the location parameter of a standard Gumbel distribution. This provides a mapping [symbol] assigning to each scoring function Sⱼ a random scoring function via,
[symbol] (Sⱼ)( [symbol] )˜Gumbel(ρᵢⱼ,1).

One can consider this assignment as a replacement of Sᵢ with a kind of reparametrized random scoring function that has favorable properties. In numerous embodiments, this assignment [symbol] can satisfy certain key properties, such that it can be invariant to order preserving reparametrizations of S, and can encode some choice of natural ranking statistics of the models from the scoring function S that are relevant to the selection process.

Once such an assignment [symbol] (and thus ρᵢⱼ) is selected, the best model can be determined via,

argmaxₖP(k=argminᵢ [maxⱼ [symbol] (Sⱼ)( [symbol] )]).

This minimax operation can be computed in terms of ρᵢⱼ via,

argminᵢlogsumexpⱼ[ρᵢⱼ]. (1)

The values logsumexpⱼ[ρᵢⱼ] (or Gumbel ranks or rank distributions) in accordance with certain embodiments of the invention can be used to rank the candidate models in terms of such values and select the highest ranking model.

In some embodiments, rather than selecting the best model via Equation (1), some collection of the models (e.g., those which receive the lowest Gumbel ranks) may be ensembled. Processes in accordance with various embodiments of the invention can choose the n models with the lowest Gumbel ranks, logsumexpⱼ[ρᵢⱼ], and ensemble these with uniform weights. In certain embodiments, processes can choose the n models with the lowest Gumbel ranks, logsumexpⱼ[ρᵢⱼ], and ensemble these with relative weights, e.g., weights given by exponentiating their (negative) Gumbel ranks so that the i model receives the relative weight

$${w}_{i} := exp ( - {logsumexp}_{j} [ {ρ}_{ij} ] ) = {( {\sum }_{j} exp ( {ρ}_{ij} ) )}^{- 1} .$$

In several embodiments, the choice of Gumbel distributions can be generalized to other families of probability distributions which are weakly max-stable. Specifically, if Θ represents the space of parameters for the family of distributions, and if G_{θ}is the cumulative distribution function for θϵΘ, then the family is said to be weakly max-stable if

G_{θ}(x) G_{τ}(x)=G_{m(θ,τ)}(x)

for some commutative semi-group operation m:Θ×Θ→Θ. Although many of the examples described herein describe Gumbel distributions, one skilled in the art will recognize that various weakly max-stable families such as (but not limited to) generalized extreme value distributions and/or the Exp-Gamma-Gumbel family may be implemented in accordance with different embodiments of the invention.

### D. Example Embodiments

### 1. Argmin statistics for a single scoring function

To start, consider the simpler scenario with a single random scoring function S: [symbol] → [symbol] , such that S assigns scores to each model independently (conditioned on the choice of models). S can be replaced with a random function [symbol] (S): [symbol] → [symbol] such that
[symbol] (S)( [symbol] )˜Gumbel(ρᵢ,1)
   are independent Gumbel-distributed random variables for each i. The {ρᵢ} can be determined as follows:

Consider the probability of a model [symbol] being assigned the optimal score by S:

pᵢ:=P(∩_{j≠i}S( [symbol] )<S( [symbol] )),

Define ρₛ: [symbol] → [symbol] by ρ_{S}( [symbol] )=−log(pᵢ). Notice that ρ_{S} is a (non-random) function which is invariant to order preserving reparametrizations of S, effectively ranks the models using the score assigned by S, and encodes the noise inherent to S.

The values {pᵢ} may be estimated from data according to a computational process. In some embodiments, these values can be estimated via bootstrapped sampling of S, but any empirical means of estimating these values from samples of S (that is asymptotically consistent) can be used in various embodiments of the invention.

Once the {pᵢ} are estimated, one selects the best model by,
argminᵢ[ρ_{S}( [symbol] )].

As mentioned above, one way to interpret the assignment ρ_{S} is that each [symbol] is (independently) assigned a normalized random score
[symbol] (S)( [symbol] )˜−Gumbel(−ρ_{S}( [symbol] ),1).
   Then the categorical distribution of the best scoring model under S is equivalent to the distribution of the best scoring model under [symbol] (S). However, [symbol] (S) is normalized so as to be invariant to reparametrizations of S.

Such implementations can realize the selection criteria described above. It is invariant with respect to reparametrizations of the scoring functions by construction. The question of a duplicate scoring function doesn't apply in this example. Finally, it is insensitive to noisy measurements because as long as the pᵢ are estimated with an asymptotically consistent estimator, then the method itself will converge to deterministically selecting the optimal model (in this case the model which is most-likely to be ranked the best by S).

### 2. Pairwise order statistics for a single scoring function

In another embodiment, rather than fitting the locations of the Gumbels to capture the argmin statistics associated to S, processes can fit them to the pairwise order statistics. Explicitly, processes can minimize the cross-entropy H(p, q) between the empirical pairwise ordering pᵢⱼ:=P(S( [symbol] )>S( [symbol] )) and a proxy qᵢⱼ:=P( [symbol] (S)( [symbol] )> [symbol] (S)( [symbol] )). Note that this is a convex objective with a unique optimum (and can be rephrased as a logistic regression model), so that the Gumbel ranks ρᵢ assigned to each model [symbol] in this way are well-defined. Note that solving the convex optimization problem in this embodiment can be accomplished by any number of standard computational methods.

As above, the best model is selected by evaluating min[ρ_{S}( [symbol] )]. It clearly satisfies the selection criteria, but the selection procedure will converge to a procedure that selects the best model according to pairwise selection criteria filtered through the fitting of Gumbel distribution locations to each scoring function.

### 3. Argmin statistics for several scoring functions

Gumbel random variables have the following max-stability property: if X₁,...,Xₘ are independent Gumbel distributed random variables with identical scale β, but distinct locations μ₁,...,μₘ, then max(X₁,...,Xₘ) is Gumbel distributed with scale β, and location μ=βlogsumexp(μ₁/β,...,μₘ/β).

It follows that if [symbol] (S₁),..., [symbol] (Sₘ), are Gumbel-ranking proxies for the scoring functions S₁,...,Sₘ, then

[symbol]

(S):=max( [symbol] (S₁),..., [symbol] (Sₘ))

is also a Gumbel ranking of the models. Explicitly, if ρⱼᵢrepresents the location of the Gumbel-distributed random variable [symbol] (Sⱼ)( [symbol] ), then [symbol] (S)( [symbol] ) is Gumbel distributed with location:

ρᵢ:=βlogsumexp(ρᵢ₁/β,...,ρᵢₘ/β).

It follows that the odds of [symbol] (S)( [symbol] )< [symbol] (S)( [symbol] ) are σ(ρⱼ−ρᵢ), where σ is the sigmoid. In particular, the model with minimal ρᵢ is the model most likely to satisfy

$${argmin}_{i} {max}_{j} ℱ ( {S}_{j} ) ( {ℳ}_{i} ) . \qquad ( 2 )$$

Therefore, combining the ρᵢⱼ via logsumexpⱼ in accordance with a variety of embodiments of the invention is justified in the setting of multiple scoring functions and essentially reduces the matter of selecting the best model to the single-scoring function setting.

One embodiment associated to argmin statistics for several scoring functions looks as follows:

Consider the probability of a model [symbol] being assigned the optimal score by Sⱼ.

pᵢⱼ:=P(∩_{k≠i}Sⱼ( [symbol] )<Sⱼ( [symbol] )).

Define ρᵢⱼ:=−log(pᵢⱼ). Notice that ρᵢⱼ is a (non-random) function which captures the negative log probability of model i being given the best score by scoring model j.

Then per the above, the best model can be computed by evaluating,
argminᵢlogsumexpⱼ[ρᵢⱼ].

As in the previous embodiments, this example relies on a computational means of estimating the pᵢⱼ incorporating sampling of the values of the scoring functions {Sⱼ}, such as averaging over bootstrapped samples.

### 4. Pairwise statistics for several scoring functions

Following the above example on pairwise ranking statistics, a similar method can be applied to pairwise statistics for multiple scoring functions. Explicitly, processes in accordance with some embodiments of the invention can minimize the cross-entropy H(p, q) between the empirical pairwise ordering statistics pᵢₖⱼ:=P(Sⱼ( [symbol] )>Sⱼ( [symbol] )) and a proxy qᵢₖⱼ:=P( [symbol] (Sⱼ)( [symbol] )> [symbol] (Sⱼ)( [symbol] )). Note that this is a convex objective with a unique optimum (and can be rephrased as a logistic regression model), so that the Gumbel ranks ρᵢ assigned to each model [symbol] in this way are well-defined. Note that solving the convex optimization problem in such embodiments can be accomplished by any number of standard computational methods.

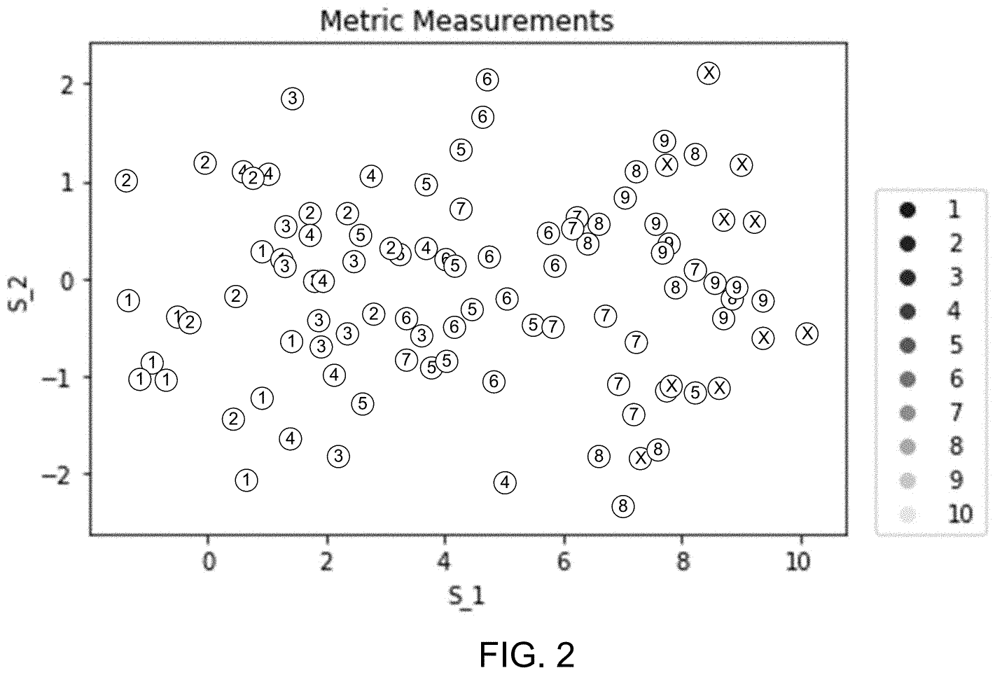

A simulated example of a method in accordance with a number of embodiments of the invention is illustrated in FIGS. 2-4. An example of results from an evaluation of ten models across two stochastic metrics is illustrated in FIG. 2. In this example, the two stochastic metrics were generated as:

S₁( [symbol] )=i+ξ,ξ˜N(0,1) (3)

S₂( [symbol] )=η,η˜N(0,1) (4)

The first metric S₁ is informative, but perturbed by Gaussian noise, while the second metric consists only of noise. In particular, the true rank of the models is given by their indices, explicitly:

[symbol]

₁, [symbol] ₂, [symbol] ₃, [symbol] ₄, [symbol] ₅, [symbol] ₆, [symbol] ₇, [symbol] ₈, [symbol] ₉, [symbol] ₁₀ (5)

Each metric was sampled 10 times, as illustrated in the chart of FIG. 2.

Using the standard minimax ranking, computed using a single measurement of each metric for each model, leads to the following final ranks of the models:
[symbol] ₁, [symbol] ₈, [symbol] ₂, [symbol] ₅, [symbol] ₃, [symbol] ₄, [symbol] ₆, [symbol] ₉, [symbol] ₇, [symbol] ₁₀
   This is far from the optimal.

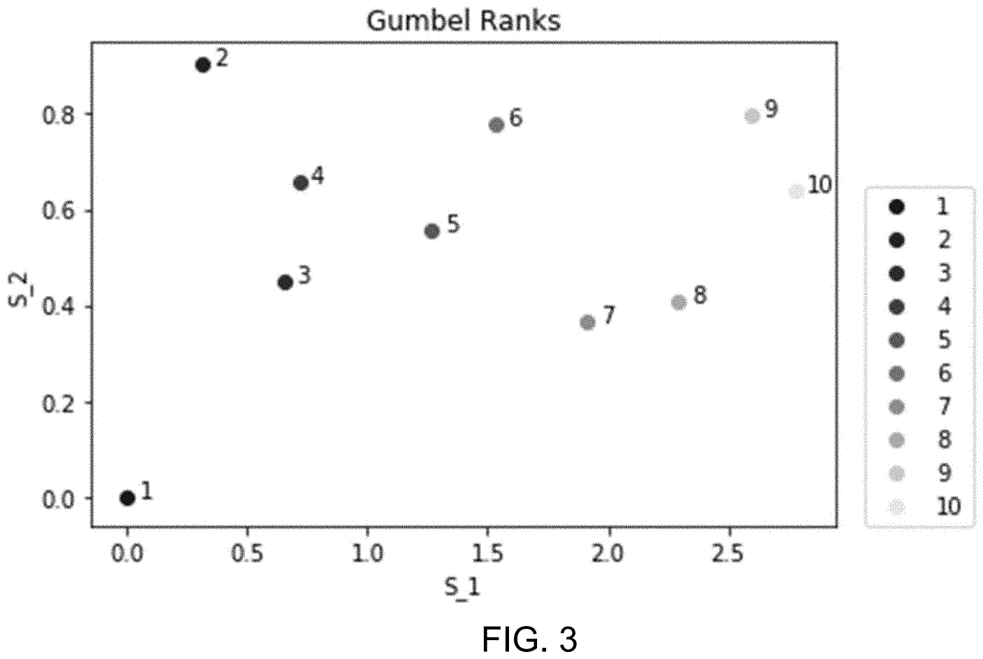

Processes in accordance with several embodiments of the invention can assign Gumbel rankings to the models using pairwise order statistics. An example of Gumbel rankings is illustrated in FIG. 3. Notice the difference in scale between the Gumbel ranks corresponding to the informative measure S₁, and the non-informative measure S₂.

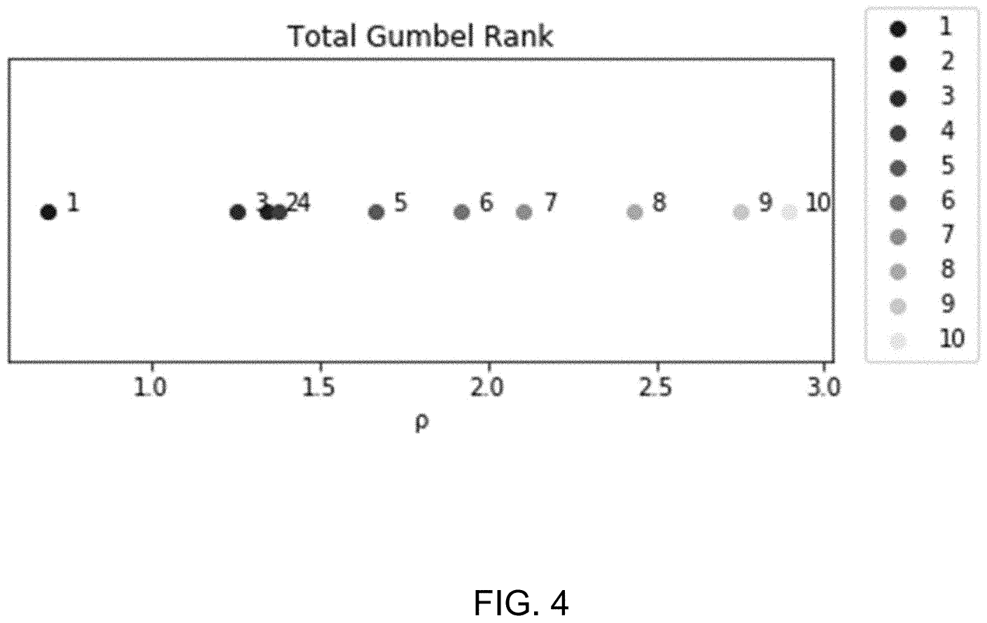

A chart with the resulting values for ρ for the total Gumbel rank is illustrated in FIG. 4. As shown, the final ranking is:
[symbol] ₁, [symbol] ₃, [symbol] ₂, [symbol] ₄, [symbol] ₅, [symbol] ₆, [symbol] ₇, [symbol] ₈, [symbol] ₉, [symbol] ₁₀
   Though the final ranking is not the optimal ranking, the results are still much closer to optimal than rankings that may result from other ranking methods.

### 5. Exp-Gamma-Gumbel Rankings

In various embodiments, the Exp-Gamma-Gumbel distribution can be used in place of the Gumbel distribution. The Exp- Gamma-Gumbel distribution corresponds to placing a Dirichlet prior on each of the corresponding categorical (or Bernoulli) distributions. This can be useful when applying the ideas above in a limited-data setting.

Suppose the random variable X is defined via the following hierarchical model:

X˜Gumbel(R,1) (6)

exp(R)˜Gamma(α,β) (7)

Then X can be called a Exp-Gamma-Gumbel distribution.

The cumulative distribution function of X is

$${( \frac{β}{β + {e}^{- x}} )}^{α} ,$$

while the probability density function is

$$\frac{α}{β} {( \frac{β}{β + {e}^{- x}} )}^{α + 1} {e}^{- x}$$

Then ρ:=log(α)−log(β) can be called the location of X, and the β shape. Note that the mode of X is ρ.

Suppose that X₁, ...,Xₙ, are independent Exp-Gamma-Gumbel distributed random variables, which common shape β=1 and locations ρ₁,...,ρₙ. Then the random variable

i:=argmaxᵢ,Xᵢ,

is a Dirichlet-Categorical distributed random variable, where the parameters of the Dirichlet distribution are

α₁:=exp(ρ₁),...,αₙ:=exp (ρₙ).

If X₁,...,Xₘare independent Exp-Gamma-Gumbel distributed random variables, with identical shapes β, and locations ρ₁,...,ρₘ, then
max(X₁,..., Xₘ)
   is Exp-Gamma-Gumbel distributed with the same shape, β, but location given by

$$ρ := log ( β {\sum }_{i} exp ( {ρ}_{i} ) ) - log ( β ) = l o g s u m e x {p}_{i} {ρ}_{i} .$$

The cdf of max(X₁,..., Xₘ) is

$$P ( max ( {X}_{1} , … , {X}_{m} ) < x ) = {\prod }_{i = 1}^{m} P ( {X}_{i} < x ) \qquad ( 8 )$$

$$= {\prod }_{i = 1}^{m} {( \frac{β}{β + {e}^{- x}} )}^{β exp ( {ρ}_{i} )} \qquad ( 9 )$$

$$= {( \frac{β}{β + {e}^{- x}} )}^{{β Σ}_{i} e x p ( {ρ}_{i} )} , \qquad ( 10 )$$

which implies that max(X₁,...,Xₘ) is Exp-Gamma-Gumbel with shape β and location

$$ρ := log ( β {\sum }_{i} exp ( {ρ}_{i} ) ) - log ( β ) = l o g s u m e x {p}_{i} {ρ}_{i} .$$

Accordingly, methods in accordance with a number of embodiments of the invention applies identically with regard to the computed location parameters, ρᵢ.

### E. Systems for Selecting and/or Ranking Models

### 6. Model Selection System

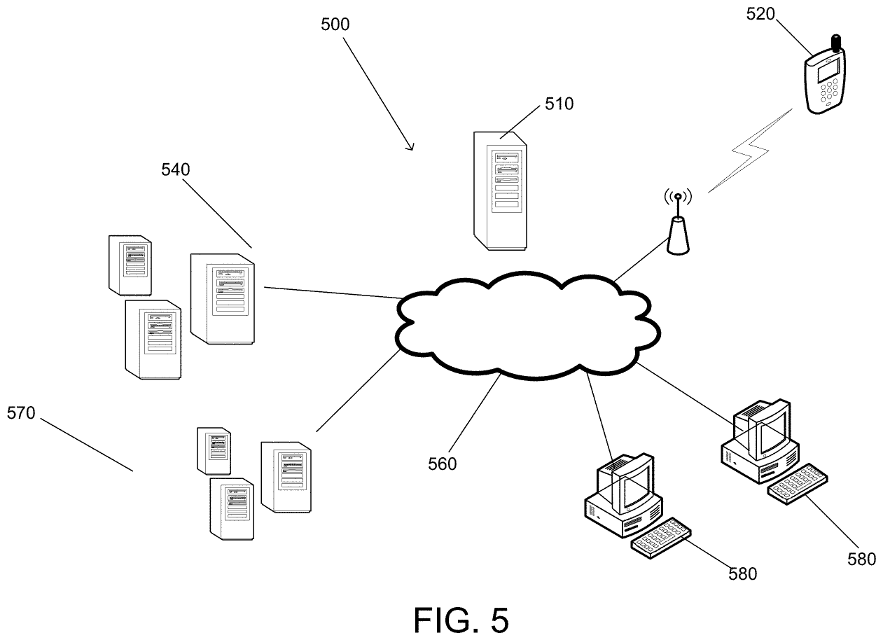

An example of a model selection system that selects and/or ranks models in accordance with an embodiment of the invention is illustrated in FIG. 5. Network 500 includes a communications network 560. The communications network 560 is a network such as the Internet that allows devices connected to the network 560 to communicate with other connected devices. Server systems 510, 540, and 570 are connected to the network 560. Each of the server systems 510, 540, and 570 is a group of one or more servers communicatively connected to one another via internal networks that execute processes that provide cloud services to users over the network 560. One skilled in the art will recognize that a model selection system may exclude certain components and/or include other components that are omitted for brevity without departing from this invention.

For purposes of this discussion, cloud services are one or more applications that are executed by one or more server systems to provide data and/or executable applications to devices over a network. The server systems 510, 540, and 570 are shown each having three servers in the internal network. However, the server systems 510, 540 and 570 may include any number of servers and any additional number of server systems may be connected to the network 560 to provide cloud services. In accordance with various embodiments of this invention, a model selection system that uses systems and methods that select and/or rank models in accordance with an embodiment of the invention may be provided by a process being executed on a single server system and/or a group of server systems communicating over network 560.

Users may use personal devices 580 and 520 that connect to the network 560 to perform processes that select and/or rank models in accordance with various embodiments of the invention. In the shown embodiment, the personal devices 580 are shown as desktop computers that are connected via a conventional “wired” connection to the network 560. However, the personal device 580 may be a desktop computer, a laptop computer, a smart television, an entertainment gaming console, or any other device that connects to the network 560 via a “wired” connection. The mobile device 520 connects to network 560 using a wireless connection. A wireless connection is a connection that uses Radio Frequency (RF) signals, Infrared signals, or any other form of wireless signaling to connect to the network 560. In the example of this figure, the mobile device 520 is a mobile telephone. However, mobile device 520 may be a mobile phone, Personal Digital Assistant (PDA), a tablet, a smartphone, or any other type of device that connects to network 560 via wireless connection without departing from this invention.

As can readily be appreciated the specific computing system used to select and/or rank models is largely dependent upon the requirements of a given application and should not be considered as limited to any specific computing system(s) implementation.

### 7. Model Selection Element

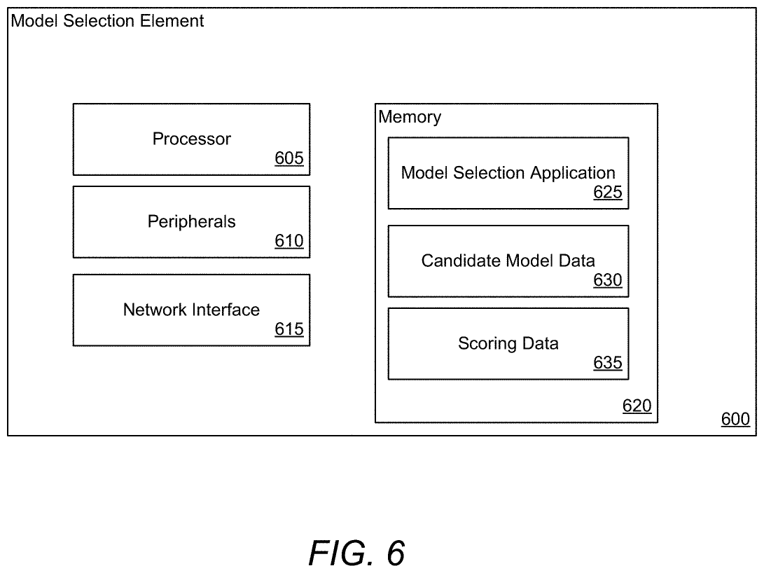

An example of a model selection element that executes instructions to perform processes that select and/or rank models in accordance with an embodiment of the invention is illustrated in FIG. 6. Model selection elements in accordance with many embodiments of the invention can include (but are not limited to) one or more of mobile devices, cameras, and/or computers. Model selection element 600 includes processor 605, peripherals 610, network interface 615, and memory 620. One skilled in the art will recognize that a model selection element may exclude certain components and/or include other components that are omitted for brevity without departing from this invention.

The processor 605 can include (but is not limited to) a processor, microprocessor, controller, or a combination of processors, microprocessor, and/or controllers that performs instructions stored in the memory 620 to manipulate data stored in the memory. Processor instructions can configure the processor 605 to perform processes in accordance with certain embodiments of the invention. In various embodiments, processor instructions can be stored on a non-transitory machine readable medium.

Peripherals 610 can include any of a variety of components for capturing data, such as (but not limited to) cameras, displays, and/or sensors. In a variety of embodiments, peripherals can be used to gather inputs and/or provide outputs. Model selection element 600 can utilize network interface 615 to transmit and receive data over a network based upon the instructions performed by processor 605. Peripherals and/or network interfaces in accordance with many embodiments of the invention can be used to gather inputs such as (but not limited to) scores, candidate model outputs, rank distributions, etc., which can be used to select and/or rank models.

Memory 620 includes a model selection application 625, candidate model data 630, and scoring data 635. Model selection applications in accordance with several embodiments of the invention can be used to select and/or rank models.

In several embodiments, candidate model data can store various parameters and/or weights for various candidate models that can be ranked and/or selected in accordance with various processes as described in this specification. Candidate model data in accordance with many embodiments of the invention can be updated through training on multimedia data captured on a model selection element or can be trained remotely and updated at a model selection element. In many embodiments, candidate model data can include outputs generated by candidate models, which can be scored by scoring models (or scoring functions) to rank the candidate models. Scoring data in accordance with various embodiments of the invention can include (but is not limited to) scores for different candidate models, scoring models, etc.

Although a specific example of a model selection element 600 is illustrated in this figure, any of a variety of model selection elements can be utilized to perform processes for selecting and/or ranking models similar to those described herein as appropriate to the requirements of specific applications in accordance with embodiments of the invention.

### 8. Model Selection Application

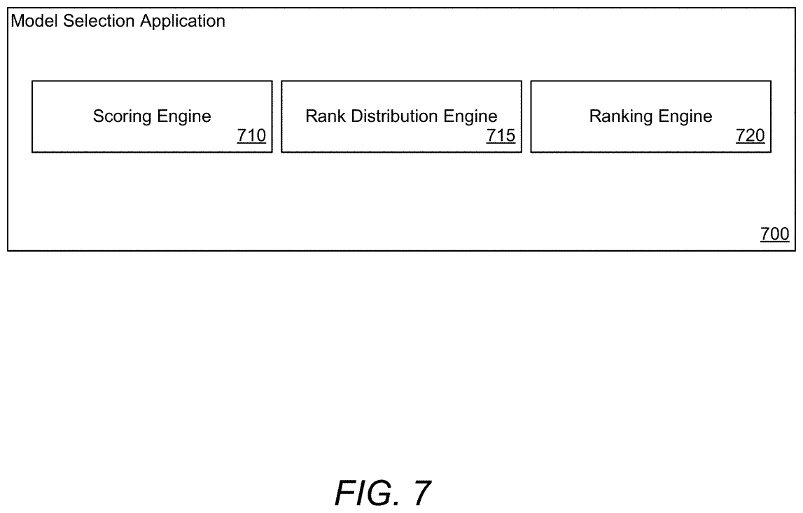

An example of a model selection application for selecting and/or ranking models in accordance with an embodiment of the invention is illustrated in FIG. 7. Model selection application 700 includes scoring engine 710, rank distribution engine 715, and ranking engine 720. One skilled in the art will recognize that a model selection application may exclude certain components and/or include other components that are omitted for brevity without departing from this invention.

Scoring engines in accordance with various embodiments of the invention can be used to score candidate models based on one or more scoring functions. In many embodiments, scoring engines can be noisy and stochastic. Scoring engines in accordance with certain embodiments of the invention can measure a characteristic of the candidate model such as (but not limited to) how well the given model captures a statistic of the data, statistical indistinguishability of samples drawn from the given model from samples of data being modeled, and a log-likelihood of the given model.

Rank distribution engines in accordance with several embodiments of the invention can be used to determine rank distributions as described herein. In many embodiments, rank distribution engines can determine rank distributions by fitting a weakly max-stable distribution to scores generated by scoring functions. Rank distributions in accordance with certain embodiments of the invention can be fitted to argmin statistics and/or pairwise order statistics.

Ranking engines in accordance with a number of embodiments of the invention can be used to rank candidate models based on determined rank distributions. Ranking the several models based on the determined rank distributions in accordance with various embodiments of the invention includes computing a logsumexp of the computed negative log probabilities associated with each model pair. Ranking the several models based on the determined rank distributions in accordance with many embodiments of the invention can include computing a logsumexp of the rank distributions. In some embodiments, ranking the several models comprises aggregating the rank distributions for each of the several candidate models to generate a total rank distribution.

Although a specific example of a model selection application is illustrated in this figure, any of a variety of model selection applications can be utilized to perform processes for selecting and/or ranking models similar to those described herein as appropriate to the requirements of specific applications in accordance with embodiments of the invention.

Although specific methods of selecting and/or ranking models are discussed above, many different methods of selecting and/or ranking models can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for ranking candidate models, the method comprising:
identifying a plurality of candidate models and a set of one or more scoring models for each of the plurality of candidate models;
determining a rank distribution for each of a plurality of model pairs, wherein:
each model pair of the plurality of model pairs comprises a candidate model of the plurality of candidate models and a scoring model of the set of scoring models; and
the rank distribution for each model pair is determined based on:
scores for the candidate model generated by the scoring model, and
scores generated by the scoring model for other candidate models of the plurality of candidate models; and
ranking the plurality of candidate models based on the determined rank distributions.

2. The method of claim 1, wherein each of the plurality of candidate models is trained to perform at least one task selected from the group consisting of regression, classification, and sample generation.

3. The method of claim 1, wherein the set of scoring models are noisy and stochastic.

4. The method of claim 1, wherein at least one scoring model of the set of scoring models measures a characteristic of the candidate model, wherein the characteristic is selected from the group consisting of how well the candidate model captures a statistic of data, statistical indistinguishability of samples drawn from the candidate model from samples of data being modeled, and a log-likelihood of the candidate model.

5. The method of claim 1, wherein determining a rank distribution for each of a plurality of model pairs comprises fitting a weakly max-stable distribution to scores generated by the scoring model.

6. The method of claim 5, wherein fitting the weakly max-stable distribution to argmin statistics comprises:
determining, for each model pair, probabilities that the candidate model is assigned an optimal score by the scoring model; and
computing a negative log of the determined probabilities.

7. The method of claim 6, wherein the probabilities are determined based on a plurality of sample scores from the scoring model for the candidate model of the model pair.

8. The method of claim 6, wherein ranking the plurality of models based on the determined rank distributions comprises computing a logsumexp of the computed negative log probabilities associated with each model pair.

9. The method of claim 5, wherein the weakly max-stable distribution is fitted to pairwise order statistics based on the scores generated by the scoring model to determine the rank distribution.

10. The method of claim 9, wherein fitting the weakly max-stable distribution to the pairwise order statistics comprises minimizing cross-entropy between empirical pairwise orderings of the scores and a proxy random function that approximates the weakly max-stable distribution to determine the rank distribution.

11. The method of claim 10, wherein each of the empirical pairwise orderings comprises a probability that a first candidate model is assigned a more optimal score than a second candidate model by a given scoring model.

12. The method of claim 11, wherein the more optimal score is a lower score.

13. The method of claim 11, wherein the probability is determined based on a plurality of sample scores from the given scoring model for the first and second candidate models.

14. The method of claim 10, wherein ranking the plurality of models based on the determined rank distributions comprises computing a logsumexp of the rank distributions.

15. The method of claim 5, wherein the weakly max-stable distribution is a Gumbel distribution and fitting the Gumbel distribution comprises computing a location parameter of the Gumbel distribution based on the scores generated by the scoring model.

16. The method of claim 5, wherein the weakly max-stable distribution is an Exp-Gamma-Gumbel distribution.

17. The method of claim 1, wherein ranking the plurality of models comprises identifying a best model based on the determined rank distributions.

18. The method of claim 1, wherein ranking the plurality of models comprises computing a logsumexp of the rank distributions of the plurality of model pairs.

19. The method of claim 1, wherein ranking the plurality of models comprises:
aggregating the rank distributions for each of the plurality of candidate models to generate a total rank distribution; and
ranking the plurality of models based on the total rank distributions.

20. The method of claim 19, wherein aggregating comprises identifying a maximum rank distribution of the rank distributions for each of the plurality of candidate models.

21. The method of claim 1, wherein ranking the plurality of models comprises ensembling a subset of the plurality of candidate models comprising models with the lowest Gumbel ranks.

22. The method of claim 21, wherein ensembling the subset of the plurality of candidate models is performed using uniform weights.

23. The method of claim 21, wherein ensembling the subset of the plurality of candidate models is performed using relative weights.

24. A non-transitory machine readable medium containing processor instructions for ranking candidate models, where execution of the instructions by a processor causes the processor to perform a process that comprises:
identifying a plurality of candidate models and a set of one or more scoring models for each of the plurality of candidate models;
determining a rank distribution for each of a plurality of model pairs, wherein:
each model pair of the plurality of model pairs comprises a candidate model of the plurality of candidate models and a scoring model of the set of scoring models; and
the rank distribution for each model pair is determined based on:
scores for the candidate model generated by the scoring model, and
scores generated by the scoring model for other candidate models of the plurality of candidate models; and
ranking the plurality of candidate models based on the determined rank distributions.
